(19) United States
(12) Patent Application Publication
(10) Pub. No.: US 2007/0005817 A1
(43) Pub. Date: Jan. 4, 2007

(54) Computer system having a wireless input device and coordinate processing method

(75) Inventors: Woon-geun Kwak, Seongnam-si (KR); Kyun-hoe Park, Suwon-si (KR); Sang-Jin Lee, Suwon-si (KR); Cheon-moo Lee, Yongin-si (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/438,215

(22) Filed: May 23, 2006

(30) Foreign Application Priority Data
May 25, 2005 (KR) 2005-44175

(51) Int. Cl. G06F 3/00

(52) U.S. Cl. 710/3

(57) ABSTRACT

A computer system having a wireless input device and a coordinate processing method, where a computer system having a wireless input device inputs coordinate information into a computer or a terminal, the computer system having a wireless input device includes: a signal reflecting device, associated with the wireless input device, to receive and reflect a first signal and one or more second signals, the signals reflected from the signal reflecting device to determine position coordinates of the wireless input device; and a signal processing device to generate and transmit the first signal and the one or more second signals to the signal reflecting device and to determine the position coordinates of the wireless input device associated with the signal reflecting device, based on the returned first and second signals reflected by the signal reflecting device.

### CROSS-REFERENCE TO RELATED APPLICATIONS

This application claims priority the benefit of priority under U.S.C. §119 from Korean Patent Application No. 2005-44175 filed on May 25, 2005, in the Korean Intellectual Property Office, the disclosure of which is incorporated herein in its entirety by reference.

### BACKGROUND OF THE INVENTION

1. Field of the Invention

Aspects of the invention relate to a computer system having a wireless input device and a coordinate processing method, and, more particularly, aspects of the invention relate to a computer system having a wireless input device that inputs coordinate information into a computer or a terminal, and a coordinate processing method of the same.

2. Description of the Related Art

Conventionally, to indicate a predetermined position on the display screen of a computer or a portable terminal, an input device such as a mouse, a touch panel, or a pen-type input device has been used. A conventional mouse has an internal rotatable roller, and, when moved on a leveled surface, the roller is rotated and the position of the mouse is input as X- and Y-coordinate information, based on the number of rotations or the direction to which the roller is rotated. The mouse is typically connected to a computer through a PS/2 or USB interface cable, and the coordinate information is transmitted via the interface cable.

Also, in addition to the coordinate input methods using the interface cable, wireless input devices have been introduced in which coordinates are transmitted in a wireless manner. For example, a receiver capable of receiving the signals of a predetermined frequency band is connected to a computer, and a wireless mouse transmits signals corresponding to the coordinate information in real time to the receiver through the predetermined frequency band. In the case of using a pen-type input device, if signals are simultaneously transmitted to the receiver in different transmission rates, the receiver calculates the time difference between the reception points of the received signals and converts the signals into coordinate information.

However, conventional wireless coordinate input methods typically require a battery to power the receiver, mouse, and pen-type input device. Further, if another mouse or pen-type input device is in close vicinity, interference can often occur. Thus, signals corresponding to coordinates are transmitted with predetermined IDs.

Japanese Unexamined Patent Publication No. 1995-36609 discloses a coordinate input device that needs no power source. The device includes a main body device provided with means to emit light to a pointing device, means to detect reflected light, and means to calculate the magnitude of movement from the reflected light to the pointing device. The pointing device is provided with means to detect the magnitude of movement, several mirrors having reflection angles which vary according to the magnitude of movement, and means to deflect the reflection of transmitted light. However, since the device is directed to a coordinate input device that needs no power source, as it utilizes reflected and transmitted light, there can be a drawback in that the device does not necessarily prevent interference between nearby coordinate input devices.

### SUMMARY OF THE INVENTION

An aspect of the invention is to provide a computer system having a wireless input device and a coordinate processing method, in which the need for a power required to transmit coordinate information can be eliminated and the interference with other coordinate input information can be prevented.

According to an aspect of the present invention, there is provided a computer system having a wireless input device. The computer system includes: a signal reflecting device, associated with the wireless input device, to receive and reflect a first signal and one or more second signals, the signals reflected from the signal reflecting device determining position coordinates of the wireless input device; and a signal processing device to generate and transmit the first signal and the one or more second signals to the signal reflecting device and to determine the position coordinates of the wireless input device associated with the signal reflecting device, based on the first and second signals reflected by the signal reflecting device.

According to another aspect of the invention, there is provided a signal reflecting device, including: a first reflecting unit to reflect a first signal and a second signal, the first and second signals to determine position coordinates of a predetermined device associated with the signal reflecting device; and at least one second reflecting unit to selectively reflect one or more of the second signals according to a user's manipulation of the predetermined device, in a corresponding predetermined time, after the second signal has been reflected by the first reflecting unit.

According to another aspect of the invention, there is provided a signal processing device, including: a first signal-generating unit to generate a first signal; a second signal-generating unit to generate a second signal; and a control unit to calculate, or determine, position coordinates of a predetermined device based on respective times from transmission of the first and second signals to receipt by the signal processing device of the returned first and second signals respectively reflected by the predetermined device.

According to another aspect of the invention, there is provided a coordinate processing method of a computer system having a wireless predetermined device, the coordinate processing method including: generating a first signal and one or more second signals each respectively transmitted with a different transmission rate to the predetermined device; and calculating, or determining, position coordinates of the predetermined device based on respective times from transmission of the first signal and the one or more second signals to receipt of the respective returned first and second signals reflected by the predetermined device. In the computer system, the predetermined device can include a wireless input device, such as mouse, a pen-type wireless input device and/or touch panel, or other suitable wireless input device.

Additional aspects and/or advantages of the invention are set forth in the description which follows or are evident from the description, or can be learned by practice of the invention.

### BRIEF DESCRIPTION OF THE DRAWINGS

These and/or other aspects and advantages of the invention will become apparent and more readily appreciated from the following description of the embodiments, taken in conjunction with the accompanying drawings of which:

FIG. 1 illustrates a computer system having a wireless input device according to an embodiment of the invention;

FIGS. 2A and 2B illustrate embodiments of signal processing devices according to aspects of the invention;

FIG. 3 illustrates a signal reflecting device according to aspects of the invention;

FIG. 4 illustrates a method of operating a signal processing device according to an embodiment of the invention;

FIG. 5 illustrates an operating waveform of a signal processing device according to aspects of the invention;

FIG. 6 illustrates position coordinates of a signal reflecting device according to aspects of the invention;

FIG. 7 illustrates operation of a signal reflecting device according to an embodiment of the invention;

FIG. 8 illustrates first and second reflecting units according to an embodiment of the invention;

FIG. 9A illustrates operation of a second reflecting unit according to an embodiment of the invention; and

FIG. 9B illustrates operation of a plurality of second reflecting units according to an embodiment of the invention.

### DETAILED DESCRIPTION OF THE EMBODIMENTS

Reference will now be made in detail to embodiments of the invention, examples of which are illustrated in the accompanying drawings, wherein like reference numerals refer to the like elements throughout. The embodiments are described below in order to explain aspects of the invention by referring to the figures, with well-known functions or constructions not necessarily being described in detail.

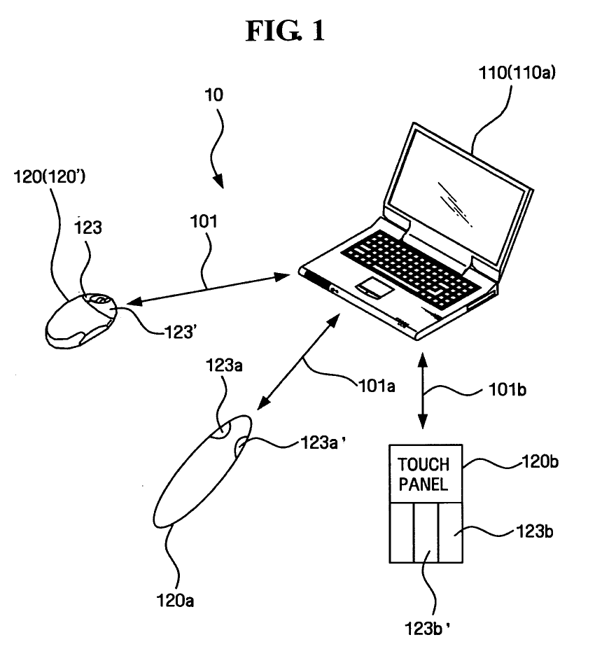

FIG. 1 illustrates a coordinate information processing system, such as the computer system 10, according to example embodiments of the invention. As illustrated, the computer system 10 having a wireless input device, such as a mouse 120, a mouse 120′, a pen-type wireless input device 120a or a touch panel 120b, for example, according to embodiments of the invention, includes embodiments of a signal processing device 110 or 110a to generate and transmit predetermined signals and to receive the signals after being reflected, according to aspects of the invention, and a signal reflecting device incorporated or associated with the mouse 120, the mouse 120′, the a pen-type wireless input device 120a or the touch panel 120b, with the signal reflecting device being designated by the same respective numerals 120, 120′, 120a or 120b, as the corresponding wireless input device, to reflect the signals transmitted from the signal processing device 110 or 110a, with the signals being transmitted/reflected being indicated by the numerals 101, 101a and 101b, for example.

Therefore, by way of example, embodiments and/or aspects of the invention are described in relation to the signal processing device 110 or 110a being a personal computer (PC), or other suitable processing device, into which coordinate information is input or a card is installed in a slot of a PC, and the signal reflecting device 120, 120′, 120a or 120b being a mouse 120 or a mouse 120′, a pen-type wireless input device 120b and/or touch panel 120c, or other suitable wireless input device, that inputs coordinate information in the signal processing device 110, although the invention is not limited in this regard.

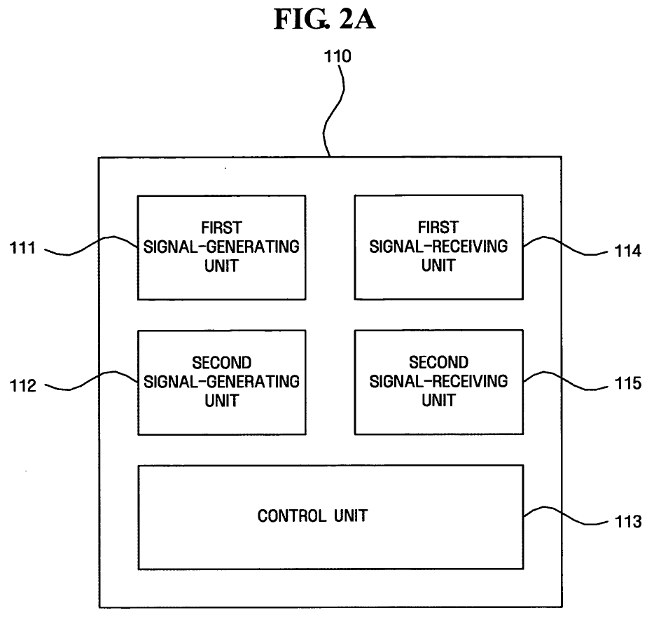

FIG. 2A illustrates the signal processing device 110 according to an embodiment of the invention. As illustrated, the signal processing device 110 includes a first signal-generating unit 111 that generates a first signal, a second signal-generating unit 112 that generates a second signal having different features or characteristics (for example, frequency and phase) from the first signal, and a control unit 113 that determines position coordinates of the signal reflecting device 120, 120′, 120a or 120b based on the first and second signals reflected from the signal reflecting device 120, 120′, 120a or 120b and that calculates, or determines, coordinate information according to the determination of the position coordinates of the signal reflecting device 120, 120′, 120a or 120b.

The signal processing device 110 further includes a first signal-receiving unit 114 that receives the reflected first signal reflected from the signal reflecting device 120, 120′, 120a or 120b, and a second signal-receiving unit 115 that receives the reflected second signal(s) reflected from the signal reflecting device 120, 120′, 120a or 120b. The first signal-receiving unit 114 receives and transmits information, such as respective time of receipt, phase and/or frequency, on the returned reflected first signal to the control unit 113 in relation to determining the position coordinates of the wireless input device, or a predetermined device, associated with the signal reflecting device 120, 120′, 120a or 120b. The second signal-receiving unit 115 receives and transmits information, such as respective time of receipt, phase and/or frequency, on the returned reflected second signal(s) to the control unit 113 in relation to determining the position coordinates of the wireless input device, or the predetermined device, associated with the signal reflecting device 120, 120′, 120a or 120b.

FIG. 2B illustrates the signal processing device 110a according to another embodiment of the invention. As illustrated, the signal processing device 110a includes the first signal-generating unit 111 that generates a first signal, but there are a plurality of second signal-generating units, such as two second signal-generating units, 112a and 112b that generate the second signals having different features or characteristics (for example, frequency and phase) from the first signal, and the control unit 113 that determines position coordinates of the signal reflecting device 120, 120′, 120a or 120b based on the first and second signals reflected from the signal reflecting device 120, 120′, 120a or 120b, and that calculates, or determines, coordinate information according to the determination of the position coordinates of the signal reflecting device 120, 120′, 120a or 120b.

The signal processing device 110a further includes the first signal-receiving unit 114 that receives the reflected first signal reflected from the signal reflecting device 120, 120′, 120a or 120b, and the second signal-receiving unit 115 that receives the reflected second signals reflected from the signal reflecting device 120, 120′, 120a or 120b. The first signal-receiving unit 114 receives and transmits information, such as respective time of receipt, phase and/or frequency, on the returned reflected first signal to the control unit 113 in relation to determining the position coordinates of the wireless input device, or a predetermined device, associated with the signal reflecting device 120, 120′, 120a or 120b. The second signal-receiving unit 115 receives and transmits information, such as respective time of receipt, phase and/or frequency, on the returned reflected second signal(s) to the control unit 113 in relation to determining the position coordinates of the wireless input device, or the predetermined device, associated with the signal reflecting device 120, 120′, 120a or 120b.

Further, by way of example, the embodiments and/or aspects of the invention are described in relation to a radio wave being used as the first signal and an ultrasonic wave being used as the second signal(s), but the invention is not limited in this regard. Alternatively, a variety of signals having different frequencies and phases can be used. Also, the elements or components 111, 112, 113, 114 and 115 of the signal processing device 110, and the elements or components 111, 112a, 112b, 113, 114 and 115 of the signal processing device 110a can be configured or formed as a single integrated hardware unit or as selectively integrated hardware units, for example. Further, in embodiments of signal processing devices according to the invention, such as the signal processing devices 110 and 110a, the first signal-generating unit 111 and the first signal-receiving unit 114 can be integrated into a hardware unit.

The control unit 113 can determine position coordinates of the signal reflecting device 120, 120′, 120a or 120b based on a time difference between the time when the first signal is received by the first signal-receiving unit 114, after the first signal has been reflected from the signal reflecting device 120, 120′, 120a or 120b, and the time when the corresponding second signal(s) is/are received by the second signal-receiving unit 115, after the second signal(s) has/have been reflected from the signal reflecting device 120, 120′, 120a or 120b, in the signal reflecting device 120, 120′, 120a or 120b. Also, the control unit 113 can be any suitable processing device, such as a processor, microprocessor or an application specific integrated circuit (ASIC), with associated memory and software or programming, to control the operations of the signal processing device, such as signal processing devices 110 and 110a, and execute the control and operations of a coordinate information processing system, such as to determine the position coordinates of the wireless input device/predetermined device/signal reflecting device 120, 120′, 120a or 120b.

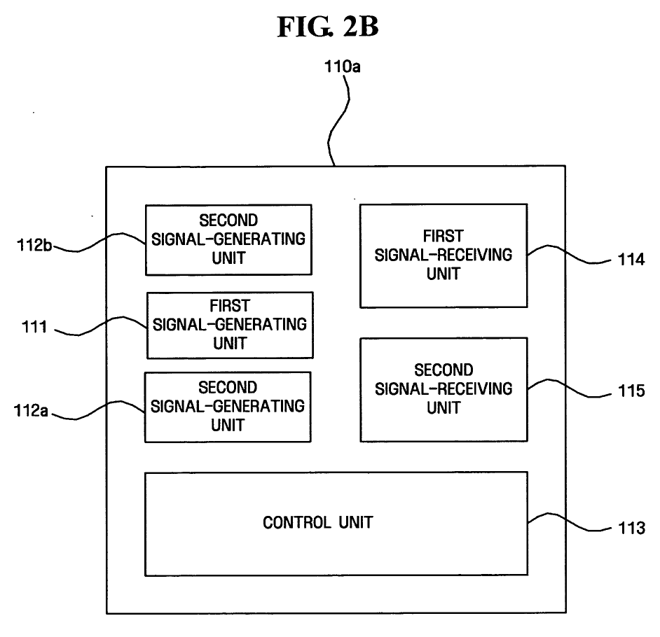

FIG. 3 illustrates the signal reflecting device 120, 120′, 120a or 120b according to an embodiment of the invention. As illustrated, the signal reflecting device 120, 120′, 120a or 120b includes a first reflecting unit 121 that reflects the first and corresponding second signal(s) and a second reflecting unit 122, 122a or 122b that selectively reflects corresponding second signal(s). The first reflecting unit 121 reflects both the first and second signals. In this regard, since the first reflecting unit 121 is typically positioned vertically to the transmitting directions of the first and second signals, the first reflecting unit 121 reflects both the first and second signals to the signal processing device 110 or 110a.

By way of example, in embodiments and/or aspects of the invention, the first signal is a radio wave and the second signal is an ultrasonic wave, although the invention is not limited in this regard. Since the first signal is typically faster than the second signal, the first signal is reflected earlier than the second signal. Accordingly, the control unit 113 can determine the position coordinates of the signal reflecting device 120, 120′, 120a or 120b based on a time difference between the time when the second signal(s) reflected by the second reflecting unit 122, 122a or 122b is/are received by the second signal receiving unit 115 of the signal processing unit 110 or 110a and the time when the first signal reflected by the first reflecting unit 121 is received by the first signal receiving unit 114 of the signal processing unit 110 or 110a. Where a plurality of second signal-generating units generate the second signal(s), such as the second signal-generating units 112a and 112b of the signal processing device 110a, the position coordinates of the signal reflecting device 120, 120′, 120a or 120b can be determined based on different time points that a plurality of second signals having different features (for example, phase or frequency) are respectively received after they have been reflected from the second reflecting unit 122, 122a or 122b.

The distance between the second reflecting unit 122, 122a or 122b and the signal processing device 110 or 110a typically is different from the distance between a first reflecting unit 121 and the signal processing device 110 or 110a, and the second reflecting unit 122, 122a or 122b can selectively reflect the second signal(s). Also, the second reflecting unit 122, 122a or 122b typically operates according to the operation by a user (for example, by operating buttons 123, 123′, 123a, 123a′, 123b or 123b′ on the respective signal reflecting device 120, 120′, 120a or 120b, such as a mouse 120 or 120′), and reflects the second signal(s) only when the user operates the wireless input device incorporated or associated with the signal reflecting device, such as a mouse. In embodiments of the invention, by way of example, the first reflecting unit 121 is described as being located closer to the signal processing device 110 or 110a than the second reflecting unit 122, 122a or 122b, but the invention is not limited in this regard. Alternatively, the distance between the first reflecting unit 121 and the signal processing device 110 or 110a can be suitably changed according to aspects of the invention.

Typically, the second reflecting unit 122, 122a or 122b functions as a filter that passes the first signal and that reflects the corresponding second signal(s). The second reflecting unit 122, 122a or 122b reflects the second signal(s) typically by being in a position vertical to the transmitting direction of the second signal(s) where the user performs an operation with the wireless input device included or associated with the signal reflecting unit 122, 122a or 122b. Otherwise, the second reflecting unit 122, 122a or 122b does not reflect the second signal(s) where the second reflecting unit 122, 122a or 122b is in a position parallel to the transmitting direction of the second signal(s). In embodiments of the invention, by way of example, the first reflecting unit 121 and the second reflecting unit 122, 122a or 122b are formed as reflectors r, r1 or r2 that can respectively reflect the first and second signals, but the invention is not limited in this regard. Alternatively, as another example, a filter, such as a bandpass filter, can be used as the first reflecting unit 121 and the second reflecting unit 122, 122a or 122b.

Accordingly, based on the second signal reflected from the second reflecting unit 122, 122a or 122b the control unit 113 determines whether the wireless input device or the predetermined device incorporated or associated with the signal reflecting device 120, 120′, 120a or 120b has been operated by the user and determines the position coordinates of the signal reflecting device 120, 120′, 120a or 120b, if the wireless input device or the predetermined device associated with the signal reflecting device 120, 120′, 120a or 120b has been operated.

As used in relation to embodiments of the invention, by way of example, a “vertical” position of the first reflecting unit 121 and the second reflecting unit 122, 122a or 122b indicates that the reflectors of the first reflecting unit 121 and the second reflecting unit 122, 122a or 122b lie or are positioned vertically with respect to the transmitting direction of the respective first and second signals, and a “parallel” position indicates that the reflectors of the first reflecting unit 121 and the second reflecting unit 122, 122a or 122b lie or are positioned in parallel to the transmitting direction of the respective first and second signals.

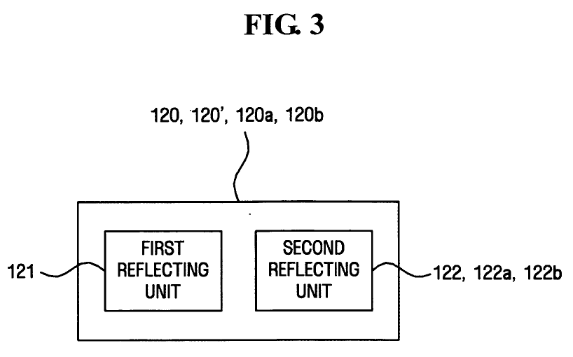

A method of operating a coordinate information processing system according to an embodiment of the invention is described with reference to FIG. 4, which illustrates a method of operating a signal processing device according to an embodiment of the invention. In the discussion of a method of operating a signal processing device, according to an embodiment of the invention, by way of example, the method is described in relation to the transmission rate of the first signal being faster than the transmission rate of the second signal, as the first and second signals are respectively transmitted in radio and ultrasonic waves.

In the method illustrated in FIG. 4, the first and second signals are respectively generated by the first signal-generating unit 111 and the second signal-generating unit 112, 112a or 112b at operation S110. Since, by way of example, the transmission rate of the first signal is typically faster than that of the second signal, the control unit 113 measures a time it took for the first signal to be reflected by the first reflecting unit 121 and received in the first signal-receiving unit 114 at operation S120.

At operation S130, the control unit 113 then measures a time it took for the one or more corresponding second signals to be received in the second signal-receiving unit 115. Based upon the measured times for the first and second signals to be reflected and respectively received in the first and second signal receiving units 114 and 115, the control unit 133 calculates, or determines, the position coordinates of the signal reflecting device 120, 120′, 120a or 120b, incorporated or associated with the wireless input device or predetermined device, based on a temporal difference between an amount of time it took from transmission for the corresponding second signal(s) to be reflected and received by the second signal-receiving unit 115 and an amount of time it took from transmission for the first signal to be reflected and received by the first signal-receiving unit 114 at operation S140.

Aspects of the invention are described, by way of example, with reference to the second signal-generating unit 112, 112a or 112b being formed on both sides of the first signal-generating unit 111, such as the second signal generating units 112a and 112b formed on opposing sides of the first signal-generating unit 111 in the signal processing device 110a, although the invention is not limited in this regard. Also, by way of example, in describing aspects of the invention, the time it took for the first signal from transmission to be reflected and received is T0, and the time it took for two second signals from transmission to be reflected and received are respectively T1 and T2. Also, in the embodiments of the invention, the signal reflecting device 120, 120′, 120a or 120b, as a predetermined device or as a wireless input device in a computer system, has, by way of example, been described in relation to a mouse 120 or 120′ provided with manipulation buttons 123 or 123′. Further, as illustrated in FIG. 1, by way of example, the signal reflecting device can also be the pen-type input device 120a provided with manipulation buttons 123a or 123a′ or the touch panel 120b provided with manipulation buttons 123b or 123b′, but the invention is not limited in this regard.

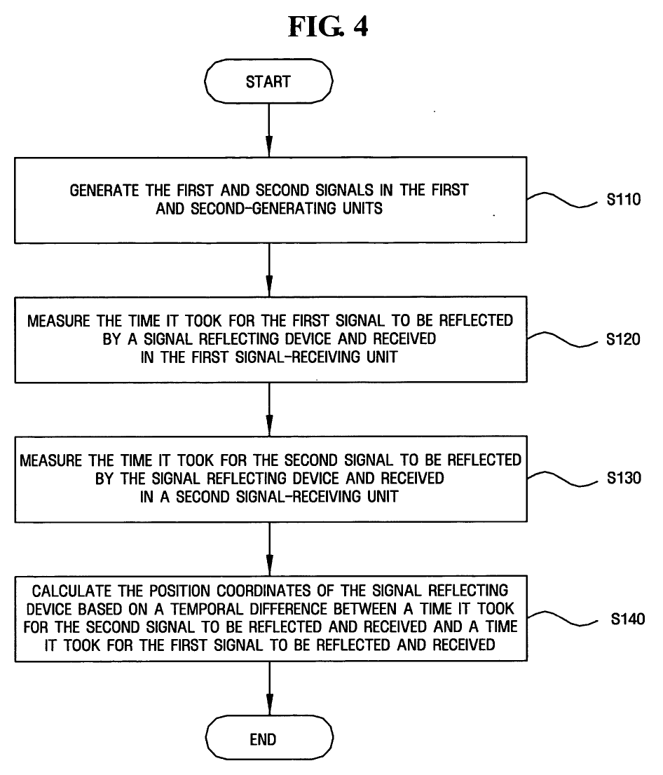

FIG. 5 illustrates an operating wave of the first and second signals reflected and received, according to an embodiment of the invention. As illustrated, the control unit 113 measures T0 (the time it took for the first signal from transmission to be reflected and received), T1 (the time it took for one of the second signals from transmission to be reflected and received), and the T2 (the time it took for another second signal from transmission to be reflected and received). Where T1 and T2 respectively correspond to two second signals, and T1 and T2 are measured with respect to the time it took for the first signal from transmission to be reflected and received, the control unit 113 calculates, or determines, position coordinates of the signal reflecting device 120, 120′, 120a or 120b by mapping the measured time(s) on a plane-coordinate grid, system or map.

Further, the first and second signals used to calculate, or determine, the position coordinates of the predetermined device/wireless input device/signal reflecting device 120, 120′, 120a or 120b in embodiments of the invention, can be reflected by a user's hand that manipulates the predetermined device/wireless input device/signal reflecting device 120, 120′, 120a or 120b or by the surface on which the predetermined device/wireless input device/signal reflecting device 120, 120′, 120a or 120b is located, in addition to being reflected by the predetermined device/wireless input device/signal reflecting device 120, 120′, 120a or 120b. Accordingly, the control unit 113 can measure the distance to the predetermined device/wireless input device/signal reflecting device 120, 120′, 120a or 120b through the first signal, and extract a corresponding second signal from the reflected second signals based on the measurement result.

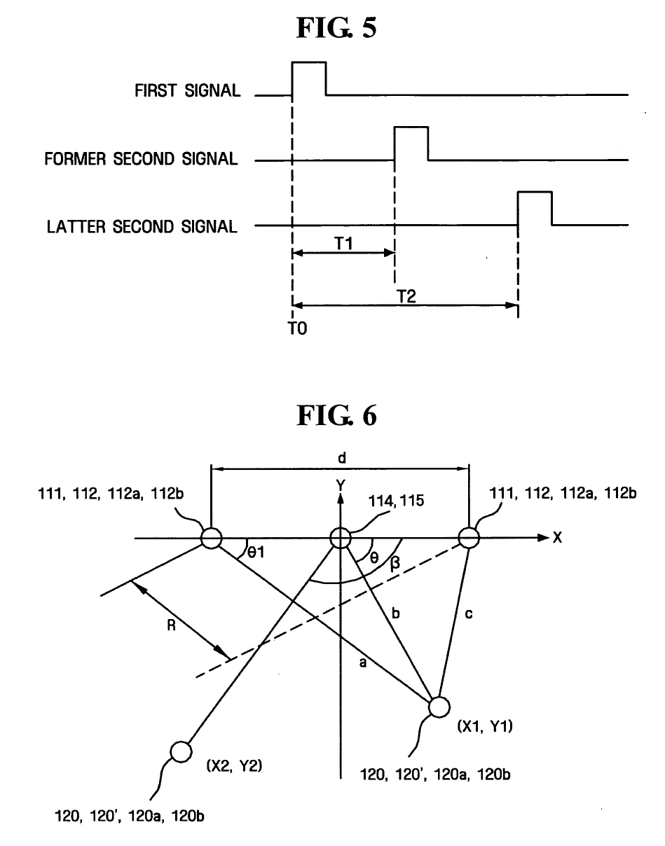

In this regard, since the first signal is transmitted as a radio wave, by way of example, in the embodiments of the invention, the control unit 113 calculates, or determines, the distance from the signal reflecting device 120, 120′, 120a or 120b based on the transmission rate of the first signal and the time it took from transmission for the first signal generated in the first signal-generating unit 111 to be reflected by a signal reflecting device 120, 120′, 120a or 120b and received in the first signal-receiving unit 114. The control unit 113 can extract the second signal(s) corresponding to the distance calculated, or determined, based on the first signal, from the two, or one or more, second signals that are received from two, or one or more, directions, and calculates, or determines, position coordinates of the signal reflecting device 120, 120′, 120a or 120b based on the extracted second signal(s).

Where examining the position coordinates calculated, or determined, by the control unit 113 as illustrated in FIG. 6, and assuming “d” is much smaller value than “b”, a≈b, a≈c can be defined. If a rate of the ultrasonic waves is V, “a” and “c” can be respectively defined as a≈T1*(V/2) and c≈T2*(V/2). Also, where a<<b, θ1≈θ is derived, and, therefore, R≈d*cos θ, θ can be derived from cos θ≈R/d=(a−c)/d=(T1*(V/2)−T2*(V/2))/d=((T1−T2)V)/2d. Further, where b is b≈(a+c)/2, b≈(T1*(V/2)+T2*(V/2))/2=(T1+T2)V/4 can be obtained, with the operator/symbol “≈” corresponding to “approximately equal to” in the above relationships.

Also, where the first signal-generating unit 111 and the first signal-receiving unit 114 are integrated into a hardware unit, according to aspects of the invention, the first signal-generating unit 111 and the first signal-receiving unit 114 can be considered to be in the same position. For example, if the transmission rate of a radio signal is V1, and a time it takes for the radio signal from transmission to be reflected and received by the signal reflecting device 120, 120′, 120a or 120b is Ts, b=V1*Ts can be derived. Accordingly, if the position coordinates of the signal reflecting device 120, 120′, 120a or 120b is (X1, Y1) in the exemplary illustration of FIG. 6, X1 and Y1 can be calculated, or determined, by X1=b*cos θ and Y1=b*sin θ, respectively. Further, where the signal reflecting device 120, 120′, 120a or 120b is located on the left side (X2, Y2) with respect to Y-axis in the exemplary illustration of FIG. 6, position coordinates can be obtained, or determined, through X2=−b*cos β and Y2=b*sin β after deriving “β” in the same manner as “θ”.

In another embodiment according to aspects of the invention, the control device 113 can calculate, or determine, the position coordinates of the predetermined device/wireless input device/signal reflecting device 120, 120′, 120a or 120b through a Doppler effect, in addition to basing the calculation, or determination, on the transmission rates of the first and second signals and the different time points at which the first and second signals are received. For example, since the transmission rate of the ultrasonic waves reflected and received by the predetermined device/wireless input device/signal reflecting device 120, 120′, 120a or 120b varies, where two ultrasonic waves having different frequencies are generated in the second signal-generating unit 112, 112a or 112b the position coordinates can be calculated, or determined, by calculating, or determining, the amount of frequency that has been varied, based on the transmission rate of the ultrasonic waves in the second signal-receiving unit 115. Where two ultrasonic waves are used, they typically are set so that the frequency of each ultrasonic wave does vary in the same region.

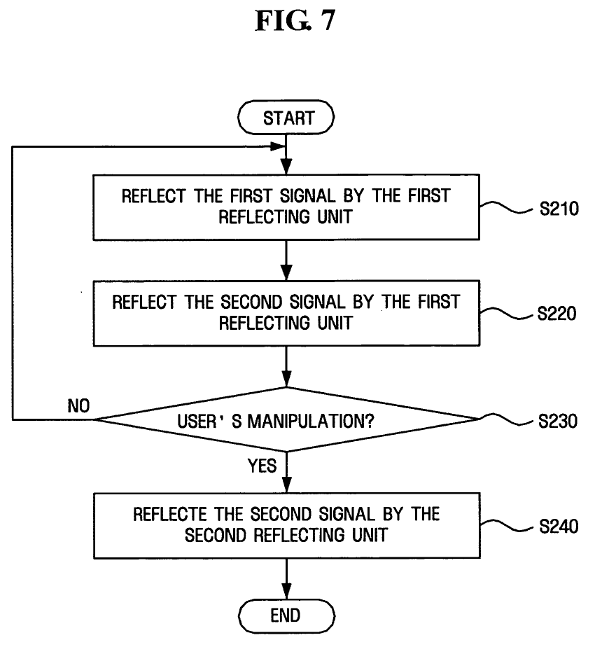

FIG. 7 illustrates a method of operating a signal reflecting device according to an embodiment of the invention. In the exemplary method of FIG. 7, the first signal received in the signal reflecting device 120, 120′, 120a or 120b has a faster transmission rate than that of the second signal(s) as described above. In the method of operating a signal reflecting device according to an embodiment of the invention of FIG. 7, the first signal generated from the signal processing device 110 is reflected from the first reflecting unit 121 at operation S210.

Similarly, the second signal generated from the signal processing device 110 is reflected by the first reflecting unit 121 in a predetermined time after the first signal has been reflected at operation S220. By reflecting the first and second signals respectively having different transmission rates, the signal processing device 110 can determine the position information of the signal reflecting device 120, 120′, 120a or 120b by measuring the time it took for the second signal(s) to be reflected and received and by calculating, or determining, a temporal difference with respect to the time it took for the first signal to be reflected and received.

When a user performs an operation, for example, clicking the button 123 or 123′ on the mouse 120 or on the mouse 120′, or clicking a button 123a or 123a′ on the pen-type input device 120a, or a button 123b or 123b′ on the touch panel 120b, at operation S230, the second reflecting unit 122, 122a or 122b reflects the second signal(s), such as by being in a position vertical to the transmitting direction of the second signal(s), at operation S240. Since the distance between the second reflecting unit 122, 122a or 122b and the signal processing unit 110 or 110a is different from that between the first reflecting unit 121 and the signal processing device 110 or 110a, the second signal reflected by the second reflecting unit 122, 122a or 122b is received in the signal processing device 110 or 110a in a time different from that of the second signal reflected by the first reflecting unit 121.

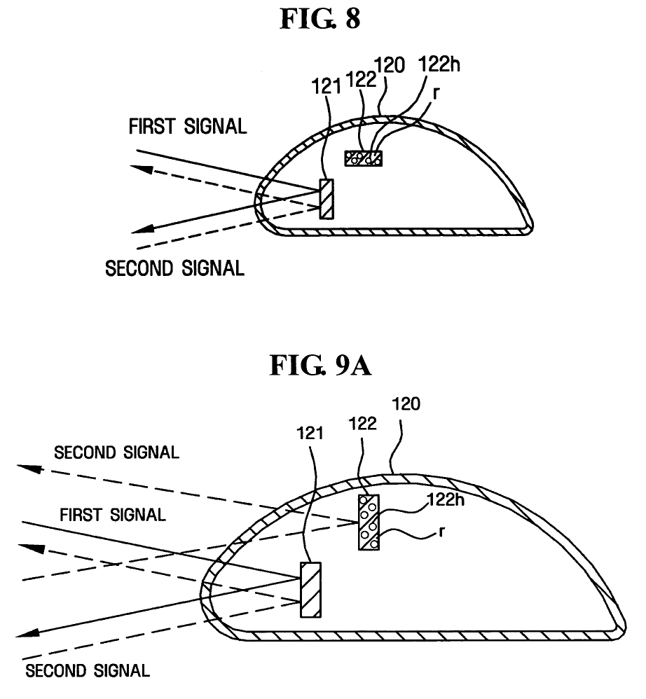

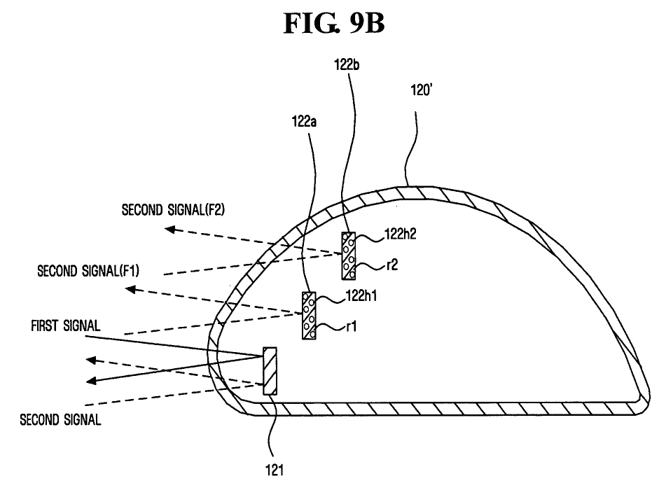

In this regard, referring, by way of example, to the mouse 120 of FIGS. 8 and 9A, where the mouse button 123 or 123′ is not operated, the first and second signals respectively generated by the first signal-generating unit 111 and the second signal-generating unit 112, 112a or 112b are reflected only by a first reflecting unit 121 as illustrated in FIG. 8. On the other hand, where the mouse button 123 or 123′ is operated, the second reflecting unit 122 initially in a position parallel to the transmitting direction of the second signal(s) is repositioned to a position vertical to the transmitting direction of the second signal as illustrated in FIG. 9A. Therefore, the second signal(s) returns to the signal processing device 110 after being reflected by the second reflecting unit 122.

Further, in embodiments of the invention, the following cases will be described with reference to the mouse 120′ of FIG. 9B as the predetermined device/signal reflecting device/wireless input device, by way of example, where the second reflecting unit 122a or 122b is farther from the signal processing device 110a than the first reflection unit 121, and where a plurality of second-reflecting units, such as two second-reflecting units, 122a and 122b are provided in the signal reflecting device 120′, incorporated or associated with the mouse 120′, and a plurality of second-signal-generating units, such as two second signal-generating units, 112a and 112b are provided in the signal processing device 110a, such as of FIG. 2B, where the second signal received earlier has been reflected from the first reflecting unit 121 and the second signal F1 or F2 received later has been reflected from a corresponding second reflecting unit 122a or 122b.

In the embodiment of the invention in FIG. 9B, where the signal reflecting device 120′ is a mouse, the number of second reflecting units, such as second reflecting units 122a or 122b, can correspond to the number of buttons, such as buttons 123 or 123′, provided on the mouse 120′, and each second reflecting unit, such as second reflecting units 122a or 122b, selectively reflects a specific frequency from the ultrasonic waves having different frequencies generated by a plurality of second-signal-generating units, such as second-signal-generating units 112a and 112b of FIG. 2B. For example, as illustrated in FIG. 2B, two second-signal-generating units 112a and 112b are provided in the signal processing device 110a of an embodiment of the invention, each generating respectively, for example, 2 MHz and 4 MHz ultrasonic waves. Where two buttons, such as buttons 123 and 123′ are provided on the mouse 120′, by way of example, the second reflecting unit 122a geared with one button 123 only reflects a 2 MHz ultrasonic wave and the second reflecting unit 122b geared with the other button 123′ only reflects a 4 MHz ultrasonic wave. In this regard, by way of example, according to aspects of the invention, where the frequency of the ultrasonic wave reflected by the second reflecting unit 122a that reflects 2 MHz ultrasonic wave increases, the frequency of ultrasonic wave reflected by the second reflecting unit 122b that reflects 4 MHz ultrasonic wave decreases. Accordingly, the control unit 113 determines the corresponding buttons, such as buttons 123 and 123′, of the wireless input device or the predetermined device, such as the mouse 120′, manipulated by a user according to the frequency and transmission rates of the reflected ultrasonic waves.

Also, according to aspects of the invention, referring to FIGS. 8, 9A and 9B, a plurality of holes, or apertures, 122h, 122h1 or 122h2 are formed on a corresponding reflector r, r1 or r2 provided in the second reflecting unit 122, 122a or 122b to reflect the ultrasonic waves, where the second reflecting unit 122, 122a or 122b is in a position to reflect the corresponding ultrasonic waves, or other suitable wavelength waves, such as in a position vertical to the transmitting direction of the ultrasonic waves. Each hole, or aperture, 122h, 122h1 or 122h2 has a predetermined depth in which an ultrasonic wave having a predetermined frequency is reflected after resonating in the corresponding hole, or aperture, 122h, 122h1 or 122h2. Accordingly, ultrasonic wave(s) having the predetermined frequency/frequencies is/are reflected by the corresponding holes, or apertures, 122h, 122h1 or 122h2 formed on the corresponding reflector r, r1 or r2, while ultrasonic waves of frequencies other than the corresponding predetermined frequency/frequencies are dampened by the holes, or apertures, 122h, 122h1 or 122h2.

A computer system having a wireless input device, according to aspects of the invention, and a coordinate processing method, according to aspects of the invention, provide, for example, one or more of the following effects and/or other effects, as described. First, where inputting coordinate information through the wireless input device, according to aspects of the invention, the need for power to operate a signal reflecting device can typically be eliminated or minimized. Second, where the signal reflecting device, as a wireless input device, can be operated by adjusting the frequency and/or frequency range of the corresponding frequency/frequencies to be reflected by the signal reflecting device, according to aspects of the invention, interference with other nearby devices, that operate at a predetermined frequency or frequencies, can be prevented in advance of operation of the wireless input device.

The foregoing embodiments, aspects and advantages are merely exemplary and are not to be construed as limiting the invention. Also, the description of the embodiments of the invention is intended to be illustrative, and not to limit the scope of the claims, and various other alternatives, modifications, and variations will be apparent to those skilled in the art. Therefore, although a few embodiments of the invention have been shown and described, it would be appreciated by those skilled in the art that changes may be made in the embodiments without departing from the principles and spirit of the invention, the scope of which is defined in the claims and their equivalents.

What is claimed is:

1. A computer system having a wireless input device, comprising:
a signal reflecting device to receive and reflect a first signal and a second signal, the first signal and the second signal reflected from the signal reflecting device to determine position coordinates of the wireless input device; and
a signal processing device to generate and transmit the first signal and the second signal to the signal reflecting device and to determine the position coordinates of the wireless input device, based on the first signal and the second signal reflected by the signal reflecting device.

2. The computer system of claim 1, wherein:
the first and second signals generated by the signal processing device are respectively transmitted with different transmission rates.

3. The computer system of claim 1, wherein the signal reflecting device includes:
a first reflecting unit to reflect the first signal; and
a second reflecting unit to selectively reflect the second signal according to a user's manipulation.

4. The computer system of claim 3, wherein:
the first reflecting unit is located in a position vertical to a transmitting direction of the first and second signals.

5. The computer system of claim 3, wherein:
the second reflecting unit is located in a position vertical to a transmitting direction of the second signal when reflecting the second signal, and
the second reflecting unit is located in a position parallel to the transmitting direction of the second signal when not reflecting the second signal.

6. The computer system of claim 1, wherein the signal processing device includes:
a first signal-generating unit to generate the first signal;
a first signal-receiving unit to receive the returned first signal reflected by the signal reflecting device;
a second signal-generating unit to generate the second signal;
a second signal-receiving unit to receive the returned second signal reflected by the signal reflecting device; and
a control unit to determine position coordinates of the wireless input device based on respective times from transmission of the first signal and the second signal, used to determine the position coordinates of the wireless input device, to receipt by the signal processing device of the returned first signal and the returned second signal, used to determine the position coordinates of the wireless input device, respectively reflected by the signal reflecting device.

7. The computer system of claim 6, wherein:
the control unit determines the position coordinates of the wireless input device based on a temporal difference between the respective time from transmission of the second signal, used to determine the position coordinates of the wireless input device, to receipt by the signal processing device of the returned reflected second signal, used to determine the position coordinates of the wireless input device, and the respective time from transmission of the first signal to receipt by the signal processing device of the returned reflected first signal.

8. A signal reflecting device, comprising:
a first reflecting unit to reflect a first signal and a second signal, the first signal and the second signal to determine position coordinates of a predetermined device; and
a second reflecting unit to selectively reflect the second signal according to a user's manipulation of the predetermined device, in a corresponding predetermined time, after the second signal has been reflected by the first reflecting unit.

9. The signal reflecting device of claim 8, wherein:
the first and second signals are respectively transmitted with different transmission rates.

10. The signal reflecting device of claim 8, wherein:
the first reflecting unit is located in a position vertical to a transmitting direction of the first and second signals.

11. The signal reflecting device of claim 8, wherein:
the second reflecting unit is located in a position vertical to a transmitting direction of the second signal when reflecting the second signal, and
the second reflecting unit is located in a position parallel to the transmitting direction of the second signal when not reflecting the corresponding second signal.

12. A signal processing device, comprising:
a first signal-generating unit to generate a first signal;
a second signal-generating unit to generate a second signal; and
a control unit to determine position coordinates of a predetermined device based on respective times from transmission of the first and second signals to receipt by the signal processing device of the returned first and second signals respectively reflected by the predetermined device.

13. The signal processing device of claim 12, wherein:
the first and second signals are respectively transmitted with different transmission rates.

14. The signal processing device of claim 12, wherein:
the control unit determines the position coordinates of the predetermined device based on a temporal difference between the respective time from transmission of the second signal to receipt by the signal processing device of the returned reflected second signal and the respective time from transmission of the first signal to receipt by the signal processing device of the returned reflected first signal.

15. The signal processing device of claim 13, further comprising:
a first signal-receiving unit to receive and transmit information on the returned reflected first signal to the control unit to determine the position coordinates of the predetermined device; and
a second signal-receiving unit to receive and transmit information on the returned reflected second signal to the control unit to determine the position coordinates of the predetermined device.

16. A coordinate processing method of a computer system having a wireless input device, the method comprising:
generating first and second signals to be respectively transmitted with different transmission rates to a predetermined device; and
determining position coordinates of the predetermined device based on respective times from transmission of the first and second signals to receipt of the returned first and second signals respectively reflected by the predetermined device.

17. The method of claim 16, further comprising:
receiving the returned first and second signals reflected by the predetermined device; and
reflecting another second signal selectively according to a user's manipulation of the predetermined device.

18. The method of claim 17, further comprising:
receiving the returned another second signal reflected by the user's manipulation of the predetermined device in a temporal difference from the returned second signal, used to determine the position coordinates of the predetermined device, reflected by the predetermined device.

19. The method of claim 16, wherein the determining the position coordinates further comprises:
determining the position coordinates of the predetermined device based on a temporal difference between the respective time from transmission of the second signal to receipt of the returned reflected second signal and the respective time from transmission of the first signal to receipt of the returned reflected first signal.

20. The method of claim 16, wherein the generating the first and second signals further comprises:
generating a plurality of the second signals to be respectively transmitted with different transmission rates to the predetermined device.

21. The method of claim 20, further comprising:
selectively reflecting the plurality of the second signals by the predetermined device.

22. The method of claim 21, further comprising:
determining a corresponding operation of the predetermined device by the selective reflection of one or more of the plurality of the second signals by the predetermined device.

23. The method of claim 16, further comprising:
reducing the power required of the predetermined device to determine the position coordinates of the predetermined device by the reflection of the first and second signals by the predetermined device.

24. The method of claim 16, further comprising:
adjusting a frequency or a frequency range of the first and second signals to reduce interference with one or more other devices.

25. The method of claim 17, further comprising:
determining a corresponding operation of the predetermined device by the selective reflection of the returned another second signal according to the user's manipulation of the predetermined device.

26. The method of claim 17, further comprising:
reducing the power required of the predetermined device to determine the position coordinates of the predetermined device by the reflection of the first and second signals by the predetermined device.

27. The method of claim 17, further comprising:
adjusting a frequency or a frequency range of the first and second signals to reduce interference with one or more other devices.

28. The signal processing device of claim 12, further comprising:
a first signal-receiving unit to receive and transmit information on the returned reflected first signal to the control unit to determine the position coordinates of the predetermined device; and
a second signal-receiving unit to receive and transmit information on the returned reflected second signal to the control unit to determine the position coordinates of the predetermined device.

29. A computer system having a wireless input device, comprising:
a signal reflecting device to receive and reflect a first signal and one or more second signals, the first signal and at least one of the one or more second signals reflected from the signal reflecting device to determine position coordinates of the wireless input device; and
a signal processing device to generate and transmit the first signal and the one or more second signals to the signal reflecting device and to determine the position coordinates of the wireless input device, based on the first signal and one or more second signals reflected by the signal reflecting device.

30. The computer system of claim 29, wherein the signal processing device includes:
a first signal-generating unit to generate the first signal;
a first signal-receiving unit to receive the returned first signal reflected by the signal reflecting device;
at least one second signal-generating unit to generate the one or more second signals;
a second signal-receiving unit to receive the returned one or more second signals reflected by the signal reflecting device; and
a control unit to determine position coordinates of the wireless input device based on respective times from transmission of the first signal and the one or more second signals, used to determine the position coordinates of the wireless input device, to receipt by the signal processing device of the returned first signal and the returned one or more second signals, used to determine the position coordinates of the wireless input device, respectively reflected by the signal reflecting device.

31. The computer system of claim 30, wherein the signal reflecting device includes:
a first reflecting unit to reflect the first signal and at least one of the one or more second signals; and
at least one second reflecting unit to selectively reflect a corresponding one or more of the second signals.

32. The computer system of claim 31, wherein:
at least one second reflecting unit that respectively reflects at least one of the second signals determines a corresponding operation of the wireless input device by the selective reflection of a corresponding at least one of the second signals.

33. The computer system of claim 32, wherein:
the signal reflecting device comprises a plurality of the second reflecting units each to selectively reflect a corresponding second signal of the one or more second signals transmitted with different transmission rates to the predetermined device.

34. The computer system of claim 29, wherein the signal reflecting device includes:
a first reflecting unit to reflect the first signal and at least one of the second signals; and
at least one second reflecting unit to selectively reflect a corresponding one or more of the second signals.

35. The computer system of claim 34, wherein:
at least one second reflecting unit that respectively reflects at least one of the second signals determines a corresponding operation of the wireless input device by the selective reflection of a corresponding at least one of the second signals.

36. The computer system of claim 34, wherein:
the signal reflecting device comprises a plurality of the second reflecting units each to selectively reflect a corresponding second signal of the one or more second signals transmitted with different transmission rates to the predetermined device.

37. The computer system of claim 36, wherein:
the first reflecting unit reflects the first signal and at least one second signal, used to determine the position coordinates of the wireless input device, of the one or more second signals.

38. The computer system of claim 37, wherein:
at least one second reflecting unit determines a corresponding operation of the wireless input device by the selective reflection of a corresponding second signal of the one or more second signals.

39. The computer system of claim 34, wherein:
the signal reflecting device comprises a plurality of the second reflecting units each comprising a reflector having a plurality of apertures to selectively reflect a corresponding second signal of the one or more second signals of a predetermined frequency and not reflect signals of other than the predetermined frequency.

40. A signal reflecting device, comprising:
a first reflecting unit to reflect a first signal and a second signal of a plurality of second signals, the first signal and the second signal of the plurality of second signals to determine position coordinates of a predetermined device; and
at least one second reflecting unit to selectively reflect a corresponding other of the plurality of second signals according to a user's manipulation of the predetermined device, in a corresponding predetermined time, after the second signal has been reflected by the first reflecting unit.

41. The signal reflecting device of claim 40, wherein:
the at least one second reflecting unit selectively reflects a corresponding one of the second signals of a predetermined frequency and does not reflect signals of other than the predetermined frequency.

42. The signal reflecting device of claim 40, wherein:
the at least one second reflecting unit determines a corresponding operation of the predetermined device by the selective reflection of a corresponding one of the second signals.

43. The signal reflecting device of claim 40, wherein:
the at least one second reflecting unit comprises a reflector having a plurality of apertures to selectively reflect a corresponding one of the second signals of a predetermined frequency and not reflect signals of other than the predetermined frequency.
